(19) United States
(12) Patent Application Publication
(10) Pub. No.: US 2006/0111055 A1
(43) Pub. Date: May 25, 2006

(54) Communication system

(75) Inventors: David Frew, Newport (GB); Aileen Young, Newport (GB)

Correspondence Address: WELSH & KATZ, LTD, 120 S RIVERSIDE PLAZA, 22ND FLOOR, CHICAGO, IL, 60606, US

(73) Assignee: ICT LIMITED, Newport (GB)

(21) Appl. No.: 11/250,133

(22) Filed: Oct. 13, 2005

(30) Foreign Application Priority Data
Oct. 19, 2004 (GB) 0423147.8

(51) Int. Cl. H04B 1/02

(52) U.S. Cl. 455/101

(57) ABSTRACT

A communications system comprises two groups of antennas with a plurality of antennas in each group arranged such that in use signals transmitted from all of the antennas 1 in one group are received by all of the antennas 2 in the second group, and processing means 5 to decode the signals received by said receiving antennas, wherein transmission controlling means 3 is provided for adjusting characteristics of the signals transmitted by respective antennas of a group, the adjustment being based upon information received from said processing means.

This invention relates to a communications system.

Recently, a new communications system architecture utilising multiple antennas at both the transmitter and receiver end of the link has been proposed. This is commonly referred to as a multiple-in-multiple-out or MIMO architecture. The main advantage of such an architecture is to provide a higher data transfer rate than for conventional systems without increasing either the bandwidth or total transmission power necessary.

Increasing the data rate available is important for new applications such as video-streaming, multi-media applications etc. As a result, next generation wireless communication systems will use MIMO architecture.

By employing a MIMO system it can be shown that under favourable channel conditions the data rate may be increased n-fold over a conventional single-input-single-output (SISO) system with no increase in bandwidth and using the same amount of total transmit power. Here, n is the minimum number of either transmit or receive antennas.

The key requirement here is for favourable channel conditions. MIMO requires a multiplicity of paths between the transmit and receive antennas. Theoretically this means that from each transmit antenna to each receive antenna there are a multiplicity of paths such that in totality (i.e. across the multiplicity of paths) the path gain from each transmit antenna to each receive antenna should experience independent Rayleigh fading.

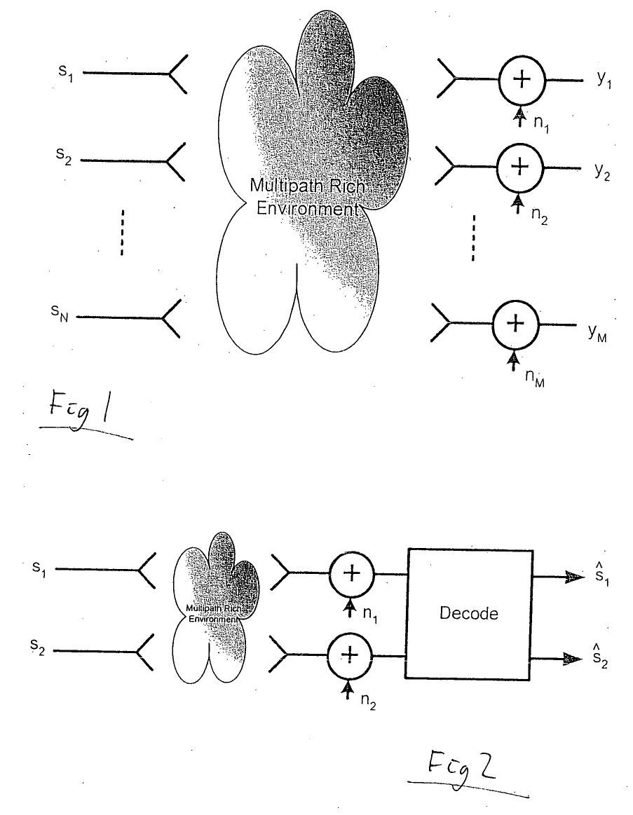

A conventional MIMO architecture is shown in FIG. 1. A group of N transmitting antennas transmit signals s₁ to s_{N} to a second group of M receiving antennas which receive signals y₁ to yₘ. In other words, each transmitting antenna transmits a distinct, individual signal. Signals are transmitted from all transmitting antennas to all receiving antennas. Therefore after reception the signals must be decoded to discriminate between the signals. Ideally, the signals are propagated through a multipath-rich environment, i.e. that signals from all transmitting antennas are scattered, for example by physical obstructions, so that signals reach the receive antennas via a multiplicity of paths. The propagation channel is therefore rich in multipath fading. Each receiving antenna also experiences thermal noise, which may be modelled as additive white Gaussian noise processes. The system model may be given by:
\vec{y}=H\vec{s}+\vec{n}
where \vec{y}, \vec{s} and \vec{n} are the received symbol vector, transmitted symbol vector and noise vector respectively. H is the propagation channel matrix.

This model makes use of the following assumptions:

a) The transmissions are narrowband, so that the maximum excess delay spread of the channel is considerably less than a symbol period;

b) There is considerable multipath activity in the propagation environment;

c) As a consequence of the multipath activity the propagation channel matrix H is assumed full (column) rank;

d) The transmitter has no knowledge of the propagation channel matrix H;

e) Each symbol is transmitted with equal power.

From the receiver or decoder's perspective, it is imperative that the channel matrix H is full rank since this is used to discriminate between received symbols for correct detection and decoding.

The full-rank conditions fall down in the following conditions:

a) There is insufficient multipath activity in the propagation environment, i.e. insufficient scattering. This could happen for example in rural environments.

b) There is a dominant line-of-sight component.

In these conditions MIMO communication attempts may fail catastrophically.

There is therefore a need for a MIMO system which is equipped with additional intelligence to determine the level of MIMO communications that are possible.

It is an object of the present invention to provide a MIMO system which can establish the level of MIMO communications possible and hence improve the reliability of MIMO communication systems.

According to a first aspect of the present invention there is provided a communications system comprising two groups of antennas with a plurality of antennas in each group arranged such that in use signals transmitted from all of the antennas in one group are received by all of the antennas in the second group, and processing means to decode the signals received by said receiving antennas, wherein transmission controlling means is provided for adjusting characteristics of the signals transmitted by respective antennas of a group, the adjustment being based upon information received from said processing means.

Advantageously, the transmission controlling means comprises beamforming means.

Advantageously, the transmitted signal characteristics are adjusted to optimise the received signals. The processing means may determine the optimised transmitted signal characteristics, based on the received signals. The processing means may determine the optimised characteristics and sends information regarding the optimised characteristics to the transmission controlling means in real-time. The characteristics are preferably optimised continuously in use.

Preferably, the characteristics of the transmitted signals comprise the power of said signals. In this case, the power distribution between transmitted signals may be optimised. The total power output of all the transmitting antennas may thus be kept constant.

Advantageously, the characteristics of the transmitted signals comprise the spatial signatures of said signals. In this case, the spatial signature of each transmitted signal may be adjusted to increase the orthogonality of that spatial signature with respect to the spatial signature of each other signal transmitted at substantially the same time. The spatial signature of each transmitted signal may be adjusted to be orthogonal to the spatial signature of each other signal transmitted at substantially the same time.

The characteristics of the transmitted signals may comprise the transmission mode used.

The antennas of at least one group may be suitable for transceiving the signals, said antennas having both a processing means and a transmission controlling means associated therewith. In this case, the transmission controlling means associated with the transceiving antenna group may adjust characteristics of the signals transmitted by said group, the adjustment being based upon information received from the processing means associated with said group.

According to a second aspect of the present invention there is provided a method of optimising transmitted signals for a communications system comprising the steps of:
transmitting respective signals from a group of antennas;
receiving each of the transmitted signals at a second group of antennas;
processing the received signals;
establishing an optimised form of respective transmitted signals;
sending information relating to the optimised form of respective signals to an antenna transmission control means;
adjusting characteristics of respective signals for transmission based upon the information received by the control means; and
transmitting respective signals with adjusted characteristics from a group of respective antennas.

Advantageously, the respective transmitted signals are beamformed by the control means.

Preferably, the optimised form of respective signals is established and the information regarding the optimised form is sent to the control means in real-time. The respective transmitted signals may be optimised continuously in use.

Advantageously, the characteristics comprise the power of said signals. In this case, the power distribution between transmitted signals may be optimised. The total power output of all the transmitting antennas may thus be kept constant.

Preferably, the characteristics comprise the spatial signatures of the signals. In this case, the spatial signature of each transmitted signal may be adjusted to increase the orthogonality of that spatial signature with respect to the spatial signature of each other signal transmitted at substantially the same time. The spatial signature of each transmitted signal may be adjusted to be orthogonal to the spatial signature of each other signal transmitted at substantially the same time.

The characteristics of the transmitted signals may comprise the transmission mode used.

The antennas of at least one group may be suitable for transceiving the signals, said antennas having both a processing means and a transmission controlling means associated therewith. In this case, the transmission controlling means associated with the transceiving antenna group may adjust characteristics of the signals transmitted by said group, the adjustment being based upon information received from the processing means associated with said group.

The invention will now be described, by way of example, with reference to the accompanying drawings, in which:—

FIG. 1 schematically shows a conventional MIMO multiple antenna system;

FIG. 2 schematically shows a MIMO system with two transmitting and receiving antennas;

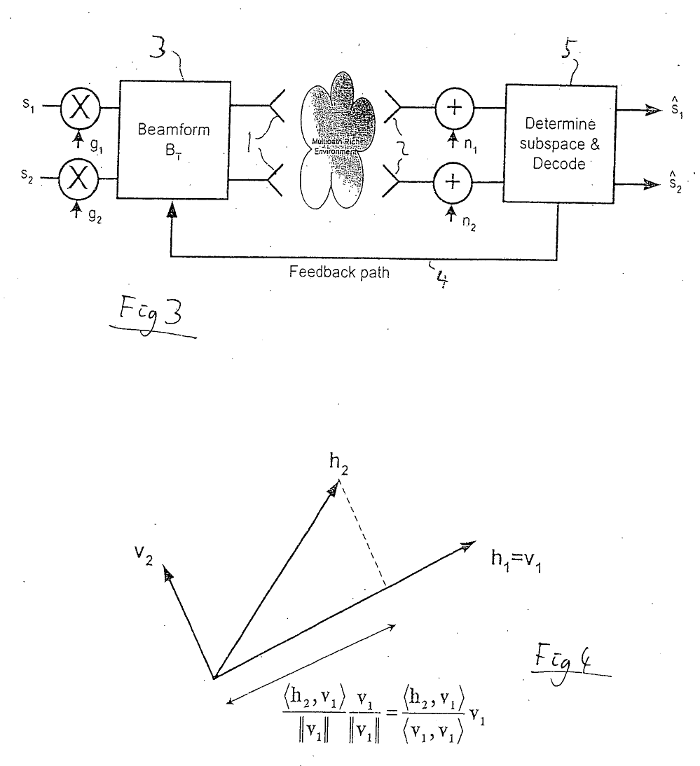

FIG. 3 schematically shows a MIMO system in accordance with the present invention; and

FIG. 4 graphically shows a Gramm-Schmidt orthogonalisation process.

The simplest form of MIMO architecture is the two transmitting antenna and two receiving antenna configuration, such as that shown in FIG. 2. Each transmitting antenna transmits a symbol taken from a known alphabet of symbols, for example BPSK (Bipolar Phase Shift Keying), QPSK (Quadrature Phase Shift Keying), 16 QAM (16 Quadrature Amplitude Modulation) etc with equal power. The transmitted symbols propagate through the channel. Each symbol therefore arrives at each of the receive antennas having undergone a complex channel gain. This can be described mathematically as:
\vec{y}=H\vec{s}+\vec{n}

Which for the two transmit two receiver case explicitly becomes

$$[ \begin{matrix}{y}_{1} \\ {y}_{2}\end{matrix} ] = [ \begin{matrix}{h}_{11} & {h}_{12} \\ {h}_{21} & {h}_{22}\end{matrix} ] [ \begin{matrix}{s}_{1} \\ {s}_{2}\end{matrix} ] + [ \begin{matrix}{n}_{1} \\ {n}_{2}\end{matrix} ]$$

The ability of the receiver to correctly decode the transmitted symbols depends upon:

i) The correct estimation of the channel matrix H by the receiver;

ii) The channel matrix H being of rank 2;

iii) There being a sufficiently high signal to noise ratio.

Here it is assumed that the receiver is able to obtain a good estimate of the channel matrix by some conventional means.

A MIMO communications system in accordance with the present invention is shown schematically in FIG. 3. Transmitting antennas 1 are arranged to transmit signals to receiving antennas 2. Ideally, transmission occurs through a multipath-rich environment. With this system, a beamforming matrix is introduced at transmission controlling means 3. In addition, a feedback path 4 is provided from the decoding processing means 5 at the receiver to the transmission controlling means 3. The transmission controlling means controls the output of the transmit antenna gain elements so that the power allocated to each transmitted symbol may be varied. The feedback is provided in real-time, continuously during use of the system to enable constant optimisation of the transmitted signals. In practice, the signals will be re-optimised within the coherence time of the channel.

At the receiver, the processing means determines the rank and subspace spanned. The simplest method to do this uses a Gramm-Schmidt orthogonalisation. This is a standard technique which for the two transmit two receive case here may be written:

$${\vec{v}}_{1} = {\vec{h}}_{1}$$

$$and$$

$${\vec{v}}_{2} = {\vec{h}}_{2} - \frac{〈 {\vec{h}}_{2} , {\vec{v}}_{1} 〉}{〈 {\vec{v}}_{1} , {\vec{v}}_{1} 〉} {\vec{v}}_{1}$$

where \vec{v}₁ and \vec{v}₂ are orthogonal basis vectors and \vec{h}₁ and \vec{h}₂ are columns of the channel matrix H, i.e. the spatial signatures of the transmitted symbols. This process is graphically shown in FIG. 4.

A measure of the rank of the matrix is given by the length (norms) of the orthogonal basis vectors \vec{v}₁ and \vec{v}₂:
∥\vec{v}₁∥&∥\vec{v}₂∥

This information is fed back to the transmitter and used to increase the reliability of the MIMO transmissions. For example, say the transmitter matrix has the form

$${B}_{T} = [ \begin{matrix}{b}_{11} & {b}_{12} \\ 0 & {b}_{22}\end{matrix} ]$$

$$where$$

$${b}_{11} = 1$$

$${b}_{12} = \frac{- 〈 {\vec{h}}_{2} , {\vec{v}}_{1} 〉 / 〈 {\vec{v}}_{1} , {\vec{v}}_{1} 〉}{\sqrt{{( 〈 {\vec{h}}_{2} , {\vec{v}}_{1} 〉 / 〈 {\vec{v}}_{1} , {\vec{v}}_{1} 〉 )}^{2} + 1}}$$

$${b}_{22} = \frac{1}{\sqrt{{( 〈 {\vec{h}}_{2} , {\vec{v}}_{1} 〉 / 〈 {\vec{v}}_{1} , {\vec{v}}_{1} 〉 )}^{2} + 1}}$$

The normalisation factor is chosen in order to maintain the same total power as for the non-beamformed case.

With this approach, each transmitted symbol will arrive with a spatial signature which is orthogonal to the spatial signature of the other symbols.

Further modification of the transmitter may be made through the dynamic allocation or distribution of power, i.e. each symbol is transmitted with a power level in order to obtain a desired level of performance with the constraint that the total power remains a constant.

This is represented mathematically as
y=HB_{T}GS+n
where G is a diagonal matrix of symbol voltage gains.

In full the system becomes:

$$[ \begin{matrix}{y}_{1} \\ {y}_{2}\end{matrix} ] = [ \begin{matrix}{h}_{11} & {h}_{12} \\ {h}_{21} & {h}_{22}\end{matrix} ] [ \begin{matrix}{b}_{11} & {b}_{12} \\ 0 & {b}_{22}\end{matrix} ] [ \begin{matrix}{g}_{1} & 0 \\ 0 & {g}_{2}\end{matrix} ] [ \begin{matrix}{s}_{1} \\ {s}_{2}\end{matrix} ] + [ \begin{matrix}{n}_{1} \\ {n}_{2}\end{matrix} ]$$

where trace(G^{H}G)=P_{T} is the power constraint.

In the extreme case, either g₁ or g₂ can be zero. This corresponds to the situation where one of the transmit antennas is not used. In the case of a two transmit antenna, two receive antenna arrangement, the system would revert in effect to a SISO configuration.

As described, the invention allows the spatial signatures to be arranged such that they are orthogonal. This has advantages for low complexity decoding schemes such as ZF. However, additional gains can be obtained from OSIC decoding by using the technique to increase the orthogonality of the spatial signatures, and this may also be applied to ML detection.

The above example ensures that the spatial signatures are made orthogonal. For certain situations though, the optimum spatial signatures may not be orthogonal. However, the beamforming technique of the present invention may also be applied to provide optimisation in such cases.

In the prior art MIMO system, shown for example in FIG. 1, the signals transmitted by each transmitting antenna are wholly distinct. For example, a first antenna transmits s1, a second antenna transmits s2 and so on. With the present invention, as a result of the beamforming this is clearly no longer the case. The system equation above shows that, with the two transmit, two receive antenna arrangement, both transmitting antennas transmit signals comprising components of both s1 and s2.

Each group of antennas will generally be capable of transceiving signals, i.e. by turns receiving and transmitting signals. For systems which operate in Time Division Duplex (TDD) mode, which incidentally includes most WLAN systems, the channel characteristics are reciprocal. That is, when a group is in receive mode, the channel information can be ascertained from a given transmitter, as described above. However, when it switches to transmit mode, it will already have all the channel characteristics it requires to perform at least an initial inventive signal optimisation with respect to the original transmitter, which would now be in receive mode. In this situation, no explicit feedback path is required.

The above example shows a full optimisation scheme. However, the present invention can be used in simpler implementations. For example, it is known that a MIMO system may transmit in a spatial multiplexing mode or in a diversity mode. Typically, use of a diversity mode provides robustness at the expense of a reduced data rate, while a multiplexing mode provides a higher rate but is more susceptible to signal impairments. The preferred may therefore be dependent on transmission conditions, e.g. environmental factors. The present invention permits the processing means associated with the receive antennas to assess the signals received, and if appropriate or necessary instruct the transmission control means to switch from one mode to the other.

While the invention has been described with reference to a two transmit two receive arrangement, this has been for simplicity only and the invention may be applied to MIMO configurations with any multiplicity of transmit and receive antennas.

It should be noted that the inventive techniques described are applicable to both wideband and narrowband systems.

For illustration only, two practical applications of the inventive MIMO system will now be described.

1. Application of MIMO Technology to Next Generation Wireless Systems

MIMO system architectures are set to revolutionise so-called next-generation communication systems. A MIMO architecture has the potential to facilitate an increase in the system data rate with no increase in the limited resources of bandwidth and power.

Wireless Local Area Network (WLAN) technology is now to be found on many consumer laptop and PDA devices, commonly as the 802.11b or Wi-Fi standard. 802.11b is just one of a number of global communication standards. 802.11b offers a top user data rate of 11 Mbits/s. Follow-on standards from 802.11b include 802.11a and 802.11g. Each new formulation of the standard has aimed at substantially increasing the on-air data rate in order to satisfy increasing user demand. The 802.11g standard for example offers a data rate of 54 Mbits/s.

The global communications industry is currently setting a new wireless LAN standard, termed 802.11n. This will be the first WLAN standard to mandate a MIMO communications mode and associated processing architectures. The aim of the standard is to achieve a user data rate in excess of 100 Mbits/s. Such a data rate offered within a wireless LAN architecture could revolutionise the usage of wireless communications within the office and home. 802.11n wireless LAN products are set to be launched in the consumer electronics marketplace by the end of 2005.

Next-generation mobile communications, also known as third generation or 3G mobile communications is set to replace current 2G systems based on the European mobile standard GSM. GSM, while being successful, is unable to service high bandwidth services such as video and multimedia.

The new standard, UMTS or 3G can offer such services, and is being rolled out worldwide. MIMO architectures and techniques were included in the first draft 3G standard, and MIMO technology has been adopted for 3G systems.

2. Wireless Sensor Networks

Wireless network technology is becoming increasingly important in many gas detection applications. The need to establish permanent or ad hoc networks can result in enhanced performance and attractive costs where the cost of wired network installation can dwarf the sensor cost.

Carbon monoxide levels in manufacturing plants and parking garages need to be diligently monitored in order to ensure the safety of pedestrians and personnel. Wiring sensors into many of these areas is prohibitively expensive. For example, in parking garages, it may be less expensive to leave exhaust fans on continuously, unnecessarily consuming enormous amounts of power than wiring in carbon monoxide sensors. Using a wireless sensor networking system, facility owners can significantly reduce their energy costs by wirelessly deploying sensors and fan actuators to maintain appropriate and regulated levels of carbon monoxide.

Monitoring the real-time levels of carbon dioxide and other volatile organic compounds within a facility such as a school is paramount for proper control of HVAC facilities. Wiring in sensors is a costly endeavour, especially for retro-fit applications. A wireless sensor networking system could reduce costs by as much as thirty percent.

In petrochemical plant installations, wireless networking offers significant cost savings over wired networks. Installation costs are dominated in conventional installations by the need to install both signal and power networks. Besides cost saving, a wireless network offers flexibility in tracking mobile assets and dealing with plant and equipment changes.

For all these sensor systems, MIMO is ideally suited. For example, each sensor may generate sensing signals which are transmitted through a respective transmit antenna. A plurality of receive antennas, which may for example be centrally located, could receive signals from all of the sensor transmit antennas and use MIMO technology to decode the respective signals. With the present invention, the received signals are analysed, and this information is fed back to the transmitters to optimise the transmitted signals. In order to preserve the cost benefits of a wireless system, the feedback should also be sent in a wireless fashion.

1. A communications system comprising two groups of antennas with a plurality of antennas in each group arranged such that in use signals transmitted from all of the antennas in one group are received by all of the antennas in the second group, and processing means to decode the signals received by said receiving antennas, wherein transmission controlling means is provided for adjusting characteristics of the signals transmitted by respective antennas of a group, the adjustment being based upon information received from said processing means.

2. A communications system according to claim 1, wherein the transmission controlling means comprises beamforming means.

3. A communications system according to claim 1, wherein the transmitted signal characteristics are adjusted to optimise the received signals.

4. A communications system according to claim 3, wherein the processing means determines the optimised transmitted signal characteristics, based on the received signals.

5. A communications system according to claim 4, wherein the processing means determines the optimised characteristics and sends information regarding the optimised characteristics to the transmission controlling means in real-time.

6. A communications system according to claim 5, wherein the characteristics are optimised continuously in use.

7. A communications system according to claim 1, wherein the characteristics of the transmitted signals comprise the power of said signals.

8. A communications system according to claim 7, wherein the power distribution between transmitted signals is optimised.

9. A communications system according to claim 8, wherein the power is distributed such that the total power output of all the transmitting antennas is constant.

10. A communications system according to claim 9, wherein the characteristics of the transmitted signals comprise the spatial signatures of said signals.

11. A communications system according to claim 10, wherein the spatial signature of each transmitted signal is adjusted to increase the orthogonality of that spatial signature with respect to the spatial signature of each other signal transmitted at substantially the same time.

12. A communications system according to claim 11, wherein the spatial signature of each transmitted signal is adjusted to be orthogonal to the spatial signature of each other signal transmitted at substantially the same time.

13. A communications system according to claim 1, wherein the characteristics of the transmitted signals comprise the transmission mode used.

14. A communications system according to claim 1, wherein the antennas of at least one group are suitable for transceiving the signals, said antennas having both a processing means and a transmission controlling means associated therewith.

15. A communications system according to claim 14, wherein in use the transmission controlling means associated with the transceiving antenna group adjusts characteristics of the signals transmitted by said group, the adjustment being based upon information received from the processing means associated with said group.

16. A method of optimising transmitted signals for a communications system comprising the steps of:
transmitting respective signals from a group of antennas;
receiving each of the transmitted signals at a second group of antennas;
processing the received signals;
establishing an optimised form of respective transmitted signals;
sending information relating to the optimised form of respective signals to an antenna transmission control means;
adjusting characteristics of respective signals for transmission based upon the information received by the control means; and
transmitting respective signals with adjusted characteristics from a group of respective antennas.

17. A method according to claim 16, wherein the respective transmitted signals are beamformed by the control means.

18. A method according to claim 17, wherein the optimised form of respective signals is established and the information regarding the optimised form is sent to the control means in real-time.

19. A method according to claim 18, wherein the respective transmitted signals are optimised continuously in use.

20. A method according to claim 17, wherein the characteristics comprise the power of said signals.

21. A method according to claim 20, wherein the power distribution between transmitted signals is optimised.

22. A method according to claim 21, wherein the power is distributed such that the total power output of all the transmitting antennas is constant.

23. A method according to claim 18, wherein the characteristics comprise the spatial signatures of the signals.

24. A method according to claim 23, wherein the spatial signature of each transmitted signal is adjusted to increase the orthogonality of that spatial signature with respect to the spatial signature of each other signal transmitted at substantially the same time.

25. A method according to claim 24, wherein the spatial signature of each transmitted signal is adjusted to be orthogonal to the spatial signature of each other signal transmitted at substantially the same time.

26. A method according to claim 16, wherein the characteristics of the transmitted signals comprise the transmission mode used.

27. A method according to claim 16, wherein the antennas of at least one group are suitable for transceiving the signals, said antennas having both a processing means and a transmission controlling means associated therewith.

28. A method according to claim 27, wherein the transmission controlling means associated with the transceiving antenna group adjusts characteristics of the signals transmitted by said group, the adjustment being based upon information received from the processing means associated with said group.
